(19) United States
(12) Patent Application Publication
(10) Pub. No.: US 2012/0177431 A1
(43) Pub. Date: Jul. 12, 2012

(54) This pen's the balm

(76) Inventor: Matthew Brian Cole, Quakertown, PA (US)

(21) Appl. No.: 13/317,580

(22) Filed: Oct. 24, 2011

Related U.S. Application Data
(60) Provisional application No. 61/460,581, filed on Jan. 6, 2011.

(51) Int. Cl. B43K 29/00; A45D 40/18

(52) U.S. Cl. 401/29; 401/143

(57) ABSTRACT

The functionality and design of this pen is two-fold. The first, lower component is used as a writing implement and the second, upper component is the compartment/housing unit of the lip balm cartridge. The bottom portion of the pen houses the ink cartridge and the mechanical components of the pen. The pen tip is retractable. The upper portion of the pen is the housing chamber for the lip balm. The snap-in design allows a lip balm cartridge to be loaded and unloaded from the pen. Both halves of the pen, top and bottom are connected. Twisting the pen at the union of the lower and upper components releases and retracts the pen tip. The uniqueness of this invention is its' dual usage, one as a pen and the other as a lip balm housing unit.

### CROSS-REFERENCE TO RELATED APPLICATIONS

This application claims benefit of provisional Application # 61/460,581 filed on Jan. 6, 2011.

### STATEMENT REGARDING FEDERALLY SPONSORED RESEARCH OR DEVELOPMENT

N/A

### REFERENCE TO SEQUENCE LISTINGS, A TABLE, OR COMPUTER PROGRAM LISTING COMPACT DISC APPENDIX

N/A

### BACKGROUND OF INVENTION

The invention is unique in the fact there are pens and lip balms available to all consumers. This invention combines both features into one, allowing the user to be able write and when need be have access and use the lip balm without searching for either item.

There is no other item that has this dual functionality of pen and lip balm combined as one.

### SUMMARY OF THE INVENTION

The invention is designed to allow the user to attach a lip balm cartridge to a pen. The express purpose is to allow a user dual functionality both as a pen as an implement to apply lip balm. The invention's goal is to eliminate the user from continuously looking for a lip balm cartridge that may be misplaced in a purse, bag, desk, etc. The user may now be able have the convenience of carrying their lip balm and pen together as one.

### BRIEF DESCRIPTION OF THE SEVERAL VIEWS OF THE DRAWING

FIG. 1 is a side view displaying the components of the upper and lower sections of the pen.

FIG. 2 is a cross-section of the inside of the lower housing unit of the pen shown in FIG. 1.

### DETAILED DESCRIPTION OF THE INVENTION

The pen is different than any other item in the fact that along with the writing component of the pen, it combines with a housing unit for a lip balm cartridge making this device unique.

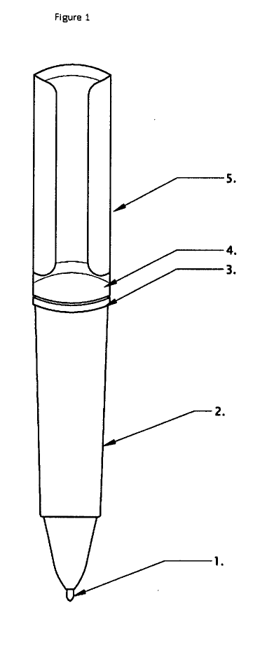

The composition of this device could be made of plastic or an aluminum/metal alloy. The pen will be constructed using a mold and has two distinct sections. The lower section, which is reflected in FIG. 1, houses part 1, the retractable pen tip; part 2, the casing for the internal pen components (ink tube); and part 3, the union of the lower and upper casing where the pen is allowed to rotate to retract the pen tip. The upper section, which is also reflected in FIG. 1, reflects part 4, the aperture in the upper housing where the lip balm cartridge can be rotated and maneuvered to release the appropriate amount of lip balm when the cap is removed. This aperture is open 180 degrees around the circumference of the upper pen casing. Part 5 illustrates where the lip balm cartridge will be stored. The vertical, slotted opening in the upper casing will open between 90 degrees and 135 degrees to accommodate loading and unloading of the lip balm cartridge.

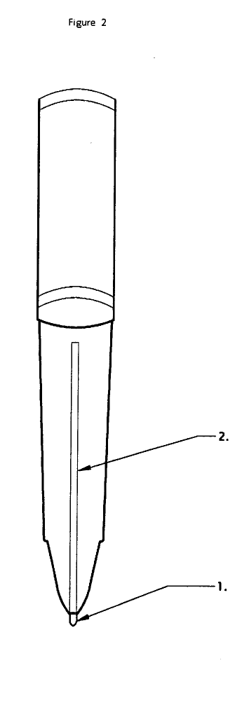

FIG. 2 demonstrates a cross-section of the pen. Part 1 shows the retractable pen tip and part 2 shows the ink tube carrying the ink.

The color of the pen FIG. 1 parts 2,3, and 5 can be any solid, pattern, or design color.

The ink used to write can be any color.

The length of the entire unit will be from 5 to 6 inches.

The pen may be altered to include rubber grips or illuminate part 2 in FIG. 1.

A metal or plastic clip may be added to the upper housing unit FIG. 1, part 5 (not provided in this diagram).

1. The pen: comprised of two components, the lower housing unit that holds the retractable pen tip and the ink tube and the upper housing unit that houses the lip balm cartridge.

2. The pen recited in claim 1, wherein the pen is constructed of a metal alloy or plastic material.

3. The pen recited in claim 1, wherein the upper housing unit has a horizontal aperture for rotating the lip balm for use once it is placed into the pen.

4. The pen recited in claim 1, wherein the upper housing unit has a vertical aperture designed to allow a lip balm tube to be snapped into place securely inside the unit.

5. The pen recited in claim 1, wherein the lower housing unit houses the ink tube and the retractable pen tip.

6. The pen recited in claim 1, wherein the pen is able to turn or rotate to allow the pen tip to retract in and out of the lower housing unit.

7. The pen recited in claim 1, wherein the lower housing unit can be molded offering a variety of designs.

8. The pen recited in claim 1, wherein the lower and upper housing unit can be of any color, pattern, or design.
